(19) United States
(12) Patent Application Publication
(10) Pub. No.: US 2024/0394515 A1
(43) Pub. Date: Nov. 28, 2024

(54) SLA-ORIENTED MODELLING OF UNCERTAINTY IN THE EXTRAPOLATION OF QUANTUM ANNEALING PERFORMANCE METRICS

(71) Applicant: Dell Products L.P., Round Rock, TX (US)

(72) Inventors: Rômulo Teixeira de Abreu Pinho, Niterói (BR); Ítalo Gomes Santana, Rio de Janeiro (BR)

(21) Appl. No.: 18/321,205

(22) Filed: May 22, 2023

(51) Int. Cl. G06N 3/047; G06N 3/045

(52) U.S. Cl. CPC G06N 3/047; G06N 3/045

(57) ABSTRACT

A method includes generating multiple instantiations of a machine learning model that has been trained, with a training dataset, to model a function that is operable to generate a prediction regarding a quantum process metric, sampling the instantiations of the machine learning model, populating an ensemble with the instantiations of the machine learning model obtained as a result of the sampling, and generating respective predictions, regarding the quantum process metric, with each of the instantiations of the machine learning model in the ensemble.

### FIELD OF THE INVENTION

Embodiments of the present invention generally relate to obtaining quantum annealing performance metrics. More particularly, at least some embodiments of the invention relate to systems, hardware, software, computer-readable media, and methods, for enabling a machine learning (ML) model to predict quantum annealing performance for circumstances outside of the domain of the data that was used to train the ML model.

### BACKGROUND

Quantum annealing processes may be used in various settings and applications including, for example, optimization problem settings. For example, a quantum annealing process may identify, from a group of solutions to a problem, the best, or optimum, solution to the problem.

Obtaining quantum annealing performance metrics to train ML models, that is, ML models that predict quantum annealing performance metrics, over large domains is challenging due at least in part to the relative scarcity of large quantum annealing hardware to run jobs and collect metrics. As a result, it may be expected that ML models to predict such performance metrics in an orchestration setting would have to extrapolate to out-of-distribution values, that is, values outside of the data that was used to train the ML model. However, ML models are known to perform poorly when extrapolating outside of the training data domains.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example embodiment, in which ML model inferences are made outside a training data domain.

FIG. 2 discloses aspects of an example graph that generally illustrates a type of uncertainty that may be modeled and utilized according to one embodiment.

FIG. 3 discloses aspects of an example architecture and method according to one embodiment.

FIG. 4 discloses an example computing entity configured and operable to perform any of the disclosed methods, processes, and operations.

### DETAILED DESCRIPTION OF SOME EXAMPLE EMBODIMENTS

Embodiments of the present invention generally relate to obtaining quantum annealing performance metrics. More particularly, at least some embodiments of the invention relate to systems, hardware, software, computer-readable media, and methods, for enabling a machine learning (ML) to predict quantum annealing performance for circumstances outside of the domain of the data that was used to train the ML model, also referred to herein simply as ‘model.’

In one example embodiment, an SLA-oriented mechanism is employed in which a Bayesian Neural Network (BNN) is trained once, and then ML models, for predicting quantum annealing performance, are sampled from the trained BNN. The number of models sampled may be a function of an SLA (service level agreement), and the models in the sample may form an ensemble of models, each of which may be an instantiation of the BNN, that may be used to perform inferencing to capture uncertainty in the predictions of quantum annealing performance, such as the expected performance of a particular optimization job in one or more given computing infrastructures. In an embodiment, such a prediction may comprise an extrapolation from quantum annealing performance metrics obtained from a model using a training dataset, and the uncertainty of that prediction may then be determined.

The membership of the ensemble may be dynamic in the sense that one or more ML models may, at various times, be added to, or deleted from, the ensemble in order to help ensure that the ensemble, as a whole, meets SLA requirements and parameters, such as a parameter specifying quantum annealing performance parameters, or a parameter specifying a maximum number of models in the ensemble. In one embodiment, models that provide relatively greater certainty in their predictions may be favored over models whose certainty of predictions is lower. However, model selection may be random in some embodiments. In an embodiment, the ensemble may be included in, or accessed by, an orchestrator that may use the predicted quantum annealing performance predictions to determine, for example, whether an optimization job should be placed in a particular computing environment or infrastructure.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that quantum annealing performance metrics may be predicted, such as by ML model inferences, outside the training data distribution for the ML model. An embodiment may avoid the need to obtain, and use, large training data sets for the entire domain where an ML model may be expected to operate. An embodiment may enable an ML model to predict quantum annealing performance metrics in domains for which the ML model has not been trained. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Performance of extrapolation in the prediction of, for example, quantum annealing performance metrics is often inevitable because the scarcity of hardware to perform a job, from which the metrics can be obtained, makes it challenging to find representative training data over large domains. For example, an optimization problem may be so large that there is not adequate infrastructure available to run the problem and obtain training data. ML models typically extrapolate poorly, so capturing the uncertainty in the extrapolations is useful in a quantum annealing orchestration setting. However, conventional approaches for capturing uncertainty in ML are usually computationally heavy and static.

In particular, and as noted earlier herein, ML models may perform poorly when it comes to extrapolating outside of the training data domains used to train the ML model. One way to address this is to model the uncertainty associated with such extrapolations. By doing this, prediction ranges and confidence intervals may be derived and provided as additional insights to an orchestrator. For example, the orchestrator may use the upper bound of the predicted execution time of a job in its orchestration decisions, that is, in its decisions to determine in which computing infrastructure that job should be executed. The following brief example is illustrative.

Suppose, for example, that a prediction is made by a model that a particular job may run to completion as slowly as 3 hours, and as quickly as 1 hour. In this case, a prediction, or uncertainty, interval of 2 hours is defined that spans the distance between the upper and lower limits. This information may be used by an orchestrator to decide where, that is, in what computing infrastructure, to place the job. Specifically, an infrastructure that can run the job in 3 hours or less may be a candidate for job placement, while an infrastructure that takes at least 4 hours to run the job would not be a candidate.

Some approaches for representing model uncertainty, that is, the uncertainty in predictions and extrapolations made by the model, include Bayesian Neural Networks (BNNs) and Model Ensembles (MEs). BNNs may be trained in such a way that each parameter of the model is actually a distribution of possible values. At inference time, each parameter may be sampled from the associated distribution before the model can yield a prediction. Several inferencing rounds may be executed to yield several outcomes, from which the uncertainty is then calculated. While BNNs are very powerful, they are computationally intensive for both the training process and the inferencing process.

By way of contrast, MEs represent a more straightforward approach, relative to BNNs, in which a pre-defined number of models, such as neural networks for example, with slightly different characteristics are trained individually and grouped in a set. At inference time, each model may yield its own outcome, or prediction, based on some input data, and the various outcomes may be combined to capture the uncertainty in a prediction. MEs are generally lighter than BNNs, computationally speaking, at inference time, but the individual training of all the models that are part of the ensemble can also be costly. In addition, the number of models in the ensemble type remains fixed.

In light of considerations such as these, one example embodiment comprises a hybrid, SLA-oriented, mechanism in which a BNN is trained once. The trained BNN may then be used to extrapolate from a training data domain to make a prediction as to, for example, some aspect of quantum annealing performance. For example, the trained BNN may make a prediction as to the values of a metric relating to performance of an optimization job in a particular computing infrastructure. Then, models from the BNN may be sampled, to the extent permitted or required by the SLA, and used to build, and/or modify, a dynamic ensemble of models. In an embodiment, the models from the BNN may each comprise a respective instantiation of the BNN. Each of the models in the ensemble may then perform an inferencing to generate a respective prediction concerning the metric of interest. The various predictions may then be combined in some way, such as statistically for example, to identify an overall prediction interval, or prediction interval, pertaining to the metric. Job orchestration decisions, and/or other decisions, may then be made based on the outcome of the uncertainty determinations, that is, based on the captured prediction interval.

### B. Aspects of an Example Embodiment of an Architecture

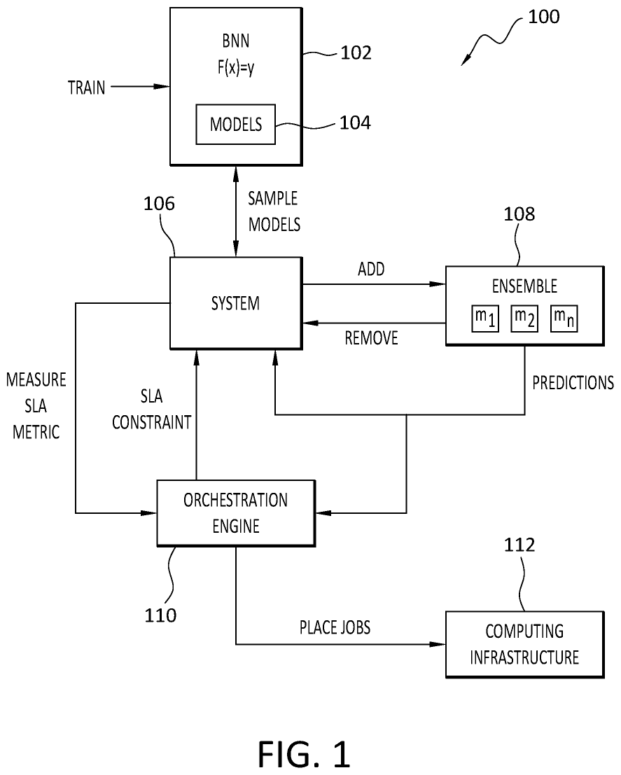

With attention now to FIG. 1, an example architecture according to one embodiment of the invention is denoted at 100. The example architecture 100 may include a neural network (NN) 102, such as a BNN (Bayesian neural network), or other suitable neural network or ML model, that may be operable to model a function F such that y=F (X), where X comprises input data, such as QUBO (quadratic unconstrained binary optimization) parameters for example, and where y is an expected, or predicted, outcome, such as, for example, a value of one or more quantum annealing performance metrics concerning execution of a job, such as an optimization job for example, in one or more particular computing infrastructures. Such quantum annealing performance metrics may comprise, for example, execution time, compilation time, compilation memory usage, and compilation CPU (central processing unit) usage. Thus, the example BNN 102 may comprise various models 104, each of which may be a respective instantiation of the BNN 102, that are each operable to generate predictions for each of one or more quantum annealing performance metrics.

As discussed in more detail elsewhere herein, the model 102 may be trained with a training dataset so as to learn to make a prediction based on the training data, such as a prediction of quantum annealing performance metrics values. However, the training dataset may be limited in scope. Thus, an embodiment of the invention may provide, among other things, a method for extrapolating from the training dataset and/or from the associated quantum annealing performance predictions obtained using that training dataset, to obtain quantum annealing performance metrics, or other information, that are out-of-distribution, that is, which are not determined by using the training dataset. Particularly, an embodiment may operate to model the uncertainty associated with those extrapolations, and orchestration decisions may then be made based on the determined uncertainty.

As further disclosed in the example of FIG. 1, the operating environment 100 may comprise a system 106, such as an SLA-oriented mechanism for example, that may communicate with the NN 102. Particularly, the system 106 may sample one or more models 104 from the NN 102 and use the sample models 104 to populate and/or modify a model ensemble 108, or simply ‘ensemble 108.’ In an embodiment, the system 106 may initiate an empty ensemble 108, and then populate the empty ensemble 108 with models. The minimum/maximum number of models 104 sampled, and/or the timing of the sampling, may be dictated by an SLA, or other specification. For example, a model 104 may be sampled, or not, based on a level of uncertainty determined with respect to predictions made by that model, that is, whether and to what extent predictions by that model correspond to measured metrics values, and/or fall within a range of acceptable performance as defined in an SLA. In one embodiment, the models 104 may be sampled randomly. Inasmuch as the models 104 may, in one embodiment, be respective instantiations of the NN 102, the models 104 may be similar, but not identical, to each other.

The system 106 may also communicate with an orchestration engine 110, which may comprise an annealing orchestration engine, of the example operating environment 100. For example, the system 106 may receive an SLA constraint from the orchestration engine 110. The system 106 may also monitor compliance with the SLA, such as by monitoring and/or measuring one or more SLA metrics identified by the orchestration engine 110.

In more detail, a computing infrastructure 112 for execution of jobs, such as large optimization problems for example, in a QUBO formulation, may comprise several types of annealers, such as digital, quantum, or simulated annealers, or even classical annealing, side-by-side with classical high-performance computation. From an orchestration engine 110 perspective, deciding where to run an optimization job in a diverse computing infrastructure 112 may be challenging. For example, the orchestration engine 110 may require inferencing capabilities, or inputs, that predict how jobs are likely to execute on some computing hardware. This input may enable the orchestration engine 110 to decide where to place each job while satisfying constraints embodied in SLA metrics for example. Such metrics for optimization jobs may comprise, for example, execution times, resource usage—for example, memory of an acceleration card, and the quality of the optimization solution, such as the value of the cost function or of the energy of the Hamiltonian.

Thus, predictions generated by the models of the ensemble 108 may be fed to the orchestration engine 110, and used by the orchestration engine 110 to make job placement decisions with respect to the computing infrastructure 112. In an embodiment, the orchestrating engine 110 may receive, from the computing infrastructure 112, performance metrics regarding the jobs placed in the infrastructure 112. These performance metrics may be compared, such as by the system 106, with SLA values and, based on the outcome of the comparison, one or more models 104 may be added to, and/or removed from, the ensemble 108. In this way, the dynamic nature of the contents of the ensemble 108 enables ongoing adjustments to the ensemble 108 to identify, and employ, those models whose predictions most closely conform with SLA requirements and actual job performance.

Thus, as used herein, ‘uncertainty’ may embrace, but is not limited to, an extent to which a prediction by a model does, or does not, conform with an actual outcome of the placement of a particular job in a computing infrastructure. The actual outcome, in turn, may or may not conform with an SLA requirement. As such, a prediction may be relatively certain in that it conforms closely with an actual outcome, but that outcome may or may not be in conformance with an SLA requirement or other specified performance parameter. Where the outcome does not so conform, future iterations of the job may be placed in a different computing infrastructure, or portion thereof, until adequate performance is achieved.

### C. Modeling Uncertainty

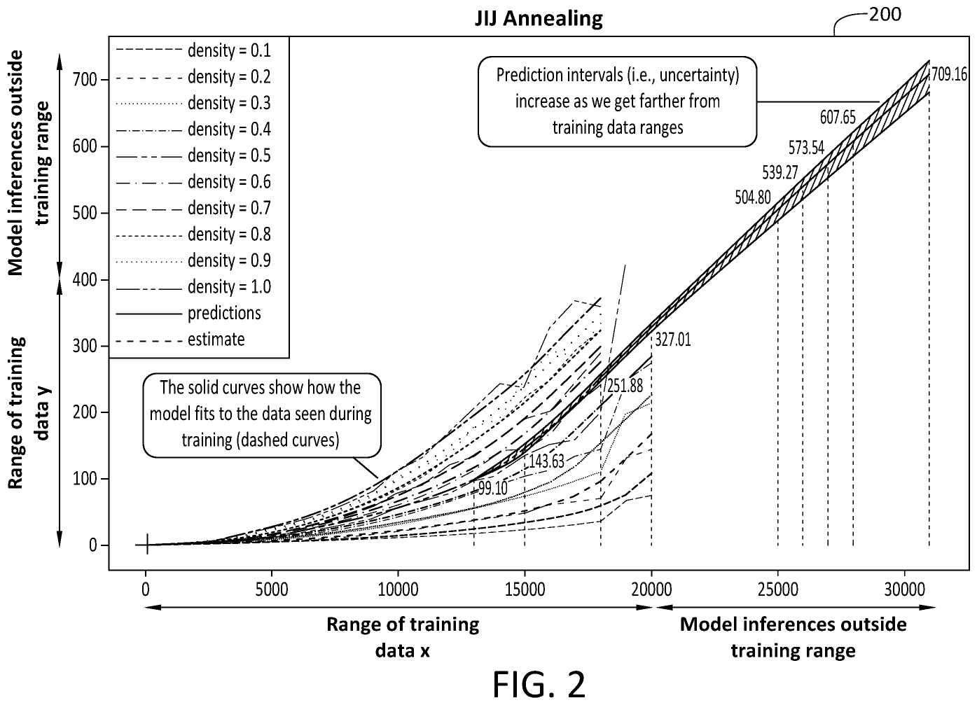

With reference now to the example of FIG. 2, a graph 200 is disclosed that generally illustrates a type of uncertainty that may be modeled, and utilized, by an embodiment of the invention. In general, it can be seen in the graph 200 that once this particular model is required to predict, by extrapolation, a value for a quantum annealing performance metric such as execution-time may be associated with performance of an optimization job in a computing infrastructure, the prediction interval, or ‘uncertainty,’ associated with the extrapolated value tends to grow with increasing distance, or extrapolation from, the training data in the training data range. For example, at ‘size’ 20000 on the x-axis, the prediction interval (or overall range of y-values, ‘time’ in this example) is significantly smaller than the prediction interval at ‘size’ 30000 on the x-axis.

Thus, an embodiment of the invention may operate to determine this prediction interval, or uncertainty, and then use that information to identify the model, or models, that provide the best performance in terms of predicting an actual outcome, such as the value of a quantum annealing performance metric. As noted herein, the uncertainty determinations may be used as a basis for job placement in a computing infrastructure.

### D. Example Methods

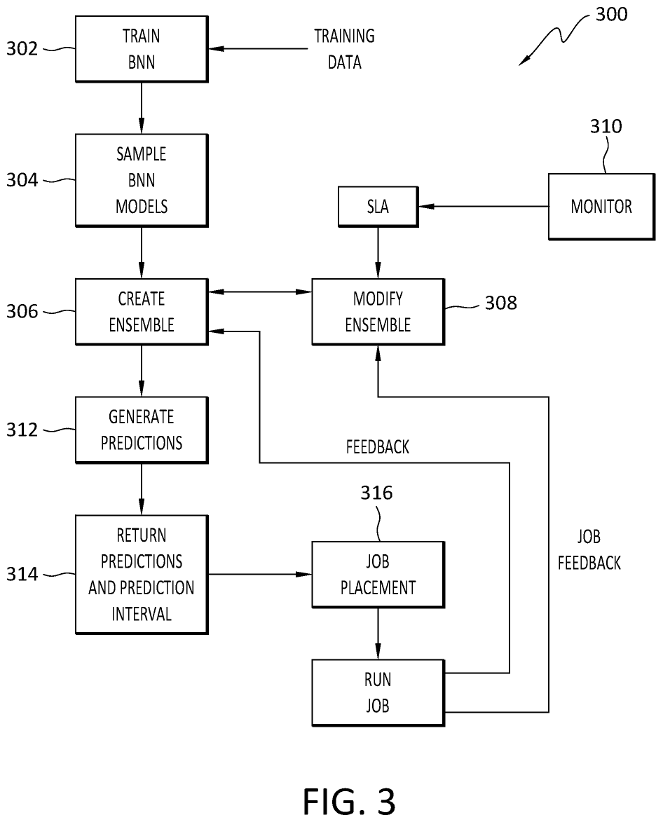

It is noted with respect to the disclosed methods, including the example method of FIG. 3 discussed below, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

One example embodiment of the invention, which may be implemented in whole or in part by a platform such as the system 106, may comprise an algorithm. Implementation of the algorithm, which may comprise three primary stages in this example, may proceed as follows:
1. train a BNN (or other NN that represents a distribution of models from which model instances can be sampled) to model a function F such that y=F (X), where X represents some input data, such as QUBO parameters, and y represents an expected outcome such as, for example, execution time, compilation time, compilation memory usage, or compilation CPU usage—in connection with this initial training process, the following additional operations may be performed:
   a. initiate an empty model ensemble E; and
   b. receive, from an annealing orchestration engine, an SLA constraint or metric that identifies the expected performance of the prediction service, for example, the number of predictions to be performed per second;
2. while monitoring an SLA metric, and during a set-up stage, do the following:
   a. sample one prediction model from the BNN and add the sample model to the ensemble E;
   b. obtain random predictions generated by the current configuration of E, that is, from the model(s) included in E;
   C. measure the monitored SLA metric as sla, that is, a specific value sla of the monitored metric—for example, if the number of models in the ensemble E is greater than the SLA allowed for number of models;
   d. if sla violates SLA, that is, for example, if the number of models in the ensemble E is greater than a maximum permitted by the SLA, remove, from the ensemble E, the model sampled in 2.a;
   e. otherwise, go to stage 3;
   f. if ensemble E is empty, inform the orchestrator that modelling uncertainty under the SLA parameters is not possible on the sampled prediction model, and repeat stage 2 to find a model that passes stage 2.e until a stopping criteria, such as a maximum number of attempts, is met;
3. while monitoring the SLA, and during normal operation, do:
   a. upon receipt of new input data from the orchestrator, obtain annealing metric predictions from ensemble E and return that set of predictions to the orchestrator;
   b. measure SLA metric as sla;
   c. if sla violates SLA, remove one prediction model from ensemble E—each model removal may follow an arbitrary policy by, for example, taking out the worst-performing model according to the current sla or by a random selection—next, if ensemble E becomes empty, attempt to set-up ensemble E again by returning to stage 2, or end the algorithm; and
   d. otherwise, if sla satisfies SLA with room for adding more models to E—for example, more than average performance of the models in ensemble E, sample one prediction model from the BNN and add it to the ensemble E.

Turning now to FIG. 3, a method according to one example embodiment is denoted at 300. Initially, a model comprising a neural network, such as a BNN for example, may be trained 302 using a training data set. In an embodiment, the model may be trained only once. The training 302 may involve training the BNN to model a particular function, or functions, examples of which may be used to generate predictions relating to quantum annealing performance metrics. Note that while the model may be trained 302 to make predictions, one or more other models may be used to perform an inferencing process, as discussed below.

In an embodiment, multiple respective instantiations, also referred to herein as ‘models,’ of the model may be created and sampled 304, possibly randomly. An ensemble of models may then be created 306, and populated with the sampled instantiations of the model. In an embodiment, an empty ensemble may be created 306 prior to performance of the sampling process, and the empty ensemble then populated with the samples.

Each of the instantiations of the BNN may be obtained by running the BNN to make inferences, or predictions, concerning whatever function the BNN was trained to model. In general, a larger number of instantiations, that is, models, may enable a better characterization of the uncertainty that results from the inferences generated by the BNN. However, an SLA, and/or other considerations, may place a limit on the number of models included in an ensemble at any given time. With respect to the example of an SLA, an SLA may specify that ‘X’ predictions/min are required. Thus, a particular number of models may be needed in the ensemble to support this SLA requirement.

At some point after the ensemble has been created 306, the ensemble may be modified 308. That is, one or more models may be added to, and/or removed from, the ensemble. The modification 308 of the ensemble may occur as a result of information obtained as a result of the monitoring 310 of an SLA, and such monitoring 310 may be ongoing. For example, more, or fewer, models may be required in an ensemble based on a change to the SLA. Where a model is removed from the ensemble, the model may be removed because its performance, as reflected, for example, by the amount of uncertainty in its predictions, lags behind the performance of other models in the ensemble. On the other hand, when a model is added to the ensemble, that model may be added because its performance, as reflected, for example, by the amount of uncertainty in its predictions, meets or exceeds the performance of other models in the ensemble.

In operation, the models in the ensemble may run, possibly on an ongoing basis, and generate predictions 312 that may be used individually and/or collectively to capture uncertainty information. That is, the predictions may be used to collectively generate or define a prediction interval, for the ensemble as a whole, that indicates an extent to which predictions of a particular outcome vary, as in the illustrative example of FIG. 2. Depending upon the performance of individual models in the ensemble, a particular model in the ensemble may contribute relatively more, or less, than another model in the ensemble, to the deviation observed in the prediction interval.

In an embodiment, the individual predictions of the models in the ensemble, along with the prediction interval, may be returned 314 to an orchestrator. The orchestrator may use this information to make various decisions. For example, the orchestrator may use the predictions and prediction interval to make a job placement decision 316, such as determining a computing infrastructure in which to place an optimization job. Once placed, the job may run 318 and feedback generated as a result of running the job may be provided, such as to the orchestrator, for use in determining whether or not the membership of the ensemble should be modified 308.

### E. Further Discussion

As will be apparent from this disclosure, example embodiments may comprise various useful features and aspects. For example, an embodiment may comprise a mechanism to combine BNNs and MEs to capture uncertainty in the prediction of annealing performance metrics outside the training data distribution, allowing users to extrapolate these metrics over large domains. As another example, an embodiment may comprise an SLA-oriented mechanism that may operate to monitor the performance of the models in an ensemble. To protect the output quality of the ensemble, this mechanism may implicitly decide the number of models in the ensemble either by removing or including models based on their performances.

### F. Further Example Embodiments

Following are some further example embodiments of the invention. These are presented only by way of example and are not intended to limit the scope of the invention in any way.

Embodiment 1. A method, comprising: generating multiple instantiations of a machine learning model that has been trained, with a training dataset, to model a function that is operable to generate a prediction regarding a quantum process metric; sampling the instantiations of the machine learning model; populating an ensemble with the instantiations of the machine learning model obtained as a result of the sampling; and generating respective predictions, regarding the quantum process metric, with each of the instantiations of the machine learning model in the ensemble.

Embodiment 2. The method as recited in any preceding embodiment, wherein the machine learning model comprises a Bayesian neural network.

Embodiment 3. The method as recited in any preceding embodiment, wherein a number of instantiations of the machine learning model in the ensemble is set by a service level agreement.

Embodiment 4. The method as recited in any preceding embodiment, wherein the quantum process metric comprises a quantum annealing performance metric.

Embodiment 5. The method as recited in any preceding embodiment, wherein one of the instantiations of the machine learning model is removed from the ensemble, based on a performance of that instantiation of the machine learning model.

Embodiment 6. The method as recited in any preceding embodiment, wherein the respective predictions generated by the instantiations of the machine learning model in the ensemble collectively define a prediction interval.

Embodiment 7. The method as recited in embodiment 6, wherein the ensemble is modified based on the prediction interval.

Embodiment 8. The method as recited in any preceding embodiment, wherein a prediction interval, associated with the respective predictions made by the instantiations of the machine learning model in the ensemble, is usable to make a quantum computing job placement decision.

Embodiment 9. The method as recited in any preceding embodiment, wherein the predictions made by the instantiations of the machine learning model in the ensemble comprise extrapolations outside of predictions that can be made by the machine learning model based on the training dataset.

Embodiment 10. The method as recited in any preceding embodiment, wherein a prediction interval collectively defined by the instantiations of the machine learning model in the ensemble is relatively smaller than a prediction interval associated with a prediction made by the machine learning model.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

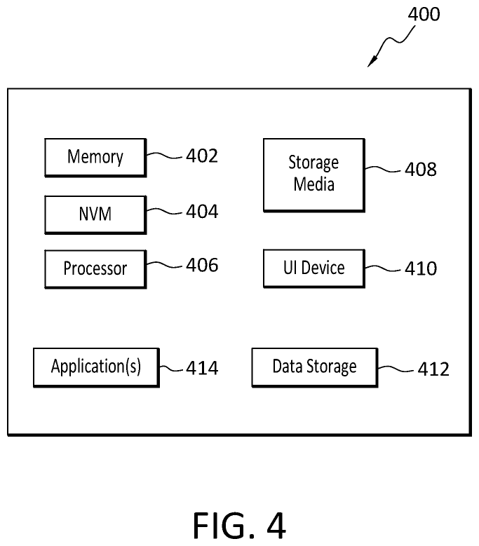

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
generating multiple instantiations of a machine learning model that has been trained, with a training dataset, to model a function that is operable to generate a prediction regarding a quantum process metric;
sampling the instantiations of the machine learning model;
populating an ensemble with the instantiations of the machine learning model obtained as a result of the sampling; and
generating respective predictions, regarding the quantum process metric, with each of the instantiations of the machine learning model in the ensemble.

2. The method as recited in claim 1, wherein the machine learning model comprises a Bayesian neural network.

3. The method as recited in claim 1, wherein a number of instantiations of the machine learning model in the ensemble is set by a service level agreement.

4. The method as recited in claim 1, wherein the quantum process metric comprises a quantum annealing performance metric.

5. The method as recited in claim 1, wherein one of the instantiations of the machine learning model is removed from the ensemble, based on a performance of that instantiation of the machine learning model.

6. The method as recited in claim 1, wherein the respective predictions generated by the instantiations of the machine learning model in the ensemble collectively define a prediction interval.

7. The method as recited in claim 6, wherein the ensemble is modified based on the prediction interval.

8. The method as recited in claim 1, wherein a prediction interval, associated with the respective predictions made by the instantiations of the machine learning model in the ensemble, is usable to make a quantum computing job placement decision.

9. The method as recited in claim 1, wherein the predictions made by the instantiations of the machine learning model in the ensemble comprise extrapolations outside of predictions that can be made by the machine learning model based on the training dataset.

10. The method as recited in claim 1, wherein a prediction interval collectively defined by the instantiations of the machine learning model in the ensemble is relatively smaller than a prediction interval associated with a prediction made by the machine learning model.

11. A non-transitory storage medium having stored therein instructions that are executable by one or more hardware processors to perform operations comprising:
generating multiple instantiations of a machine learning model that has been trained, with a training dataset, to model a function that is operable to generate a prediction regarding a quantum process metric;
sampling the instantiations of the machine learning model;
populating an ensemble with the instantiations of the machine learning model obtained as a result of the sampling; and
generating respective predictions, regarding the quantum process metric, with each of the instantiations of the machine learning model in the ensemble.

12. The non-transitory storage medium as recited in claim 11, wherein the machine learning model comprises a Bayesian neural network.

13. The non-transitory storage medium as recited in claim 11, wherein a number of instantiations of the machine learning model in the ensemble is set by a service level agreement.

14. The non-transitory storage medium as recited in claim 11, wherein the quantum process metric comprises a quantum annealing performance metric.

15. The non-transitory storage medium as recited in claim 11, wherein one of the instantiations of the machine learning model is removed from the ensemble, based on a performance of that instantiation of the machine learning model.

16. The non-transitory storage medium as recited in claim 11, wherein the respective predictions generated by the instantiations of the machine learning model in the ensemble collectively define a prediction interval.

17. The non-transitory storage medium as recited in claim 16, wherein the ensemble is modified based on the prediction interval.

18. The non-transitory storage medium as recited in claim 11, wherein a prediction interval, associated with the respective predictions made by the instantiations of the machine learning model in the ensemble, is usable to make a quantum computing job placement decision.

19. The non-transitory storage medium as recited in claim 11, wherein the predictions made by the instantiations of the machine learning model in the ensemble comprise extrapolations outside of predictions that can be made by the machine learning model based on the training dataset.

20. The non-transitory storage medium as recited in claim 11, wherein a prediction interval collectively defined by the instantiations of the machine learning model in the ensemble is relatively smaller than a prediction interval associated with a prediction made by the machine learning model.
